(19) United States
(12) Patent Application Publication
(10) Pub. No.: US 2011/0300761 A1
(43) Pub. Date: Dec. 8, 2011

(54) ELECTRICAL ADAPTER

(75) Inventors: CHIEN-CHIUNG WANG, New Taipei (TW); QING-MAN ZHU, Kunshan (CN); XUE-LIANG ZHANG, Kunshan (CN)

(73) Assignee: HON HAI PRECISION INDUSTRY CO., LTD., New Taipei (TW)

(21) Appl. No.: 13/155,479

(22) Filed: Jun. 8, 2011

(30) Foreign Application Priority Data
Jun. 8, 2010 (CN) 201020218903.4

(51) Int. Cl. H01R 25/00; H01R 31/06

(52) U.S. Cl. 439/638

(57) ABSTRACT

An electrical adapter (100) includes a connector assembly and a case receiving the connector assembly. The connector assembly has a first mating port facing forwardly to receive a first plug and a rear mating port facing backwardly for receiving a second plug. The case has a unitarily formed bushing (42) sheathing the connector assembly. The bushing (42) has a top wall (422), a bottom wall (424), two side walls (426, 428) connecting opposite sides of the top and the bottom walls (422, 424), and a number of protrusions (423, 425, 427, 429) extending from the walls (422, 424, 426, 428) and positioning the connector assembly in the bushing (42).

### BACKGROUND OF THE INVENTION

1. Field of the Invention

The present invention relates to an electrical adapter, and particularly, to an electrical adapter with simple structure.

2. Description of Related Art

U.S. Pat. No. 6,176,743, issued to Kuo on Jan. 23, 2001, discloses an electrical adapter. The adapter comprises two different types of connectors and an adapting device. The adapting device comprises a plurality of conducting pins and two printed circuit boards (PCBs). The two PCBs comprise a plurality of aligned through holes. The conducting pins are inserted through and retained in the aligned through holes of the two PCBs to connect the two PCBs. The two PCBs are contacted by three rows of terminals of the first type electrical connector on three of surfaces thereof near one end thereof One of the two PCBs is straddled by two rows of terminals of the second type electrical connector on opposite surfaces of the other end thereof.

### SUMMARY OF THE INVENTION

An object of the present invention is to provide an electrical adapter comprising a connector assembly and a case enclosing the connector assembly. The connector assembly comprises a printed circuit board having a front edge and a rear edge; a first connector mounted on the printed circuit board; a first cage mounted on the printed circuit board near the front edge; a second connector mounted on the printed circuit board; and a second cage mounted on the printed circuit board near the rear edge. The first connector defines a slot for receiving a card edge of a first plug. The first cage has a front opening through which the first plug is backwardly inserted into the first cage and a rear opening facing to the printed circuit board through which the first connector gets upwardly into the first cage when the first cage is mounted onto the printed circuit board. The second connector defines a slot for receiving a card edge of a second plug. The first cage has a front opening through which the second plug is backwardly inserted into the second cage and a rear opening facing to the printed circuit board through which the second connector get upwardly into the second cage when the second cage is mounted onto the printed circuit board. The printed circuit board electrically connects the first connector to the second connector.

Still another object of the present invention is to provide another electrical adapter comprising a connector assembly and a case receiving the connector assembly. The connector assembly has a first mating port facing forwardly to receive a first plug and a rear mating port facing backwardly for receiving a second plug. The case has a unitarily formed bushing sheathing the connector assembly. The bushing has a top wall, a bottom wall, two side walls connecting opposite sides of the top and the bottom walls, and a plurality of protrusions extending from the walls and positioning the connector assembly therein.

Other objects, advantages and novel features of the invention will become more apparent from the following detailed description of a preferred embodiment when taken in conjunction with the accompanying drawings.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an electrical adapter according to the present invention;

FIG. 2 is an exploding view of the electrical adapter shown in FIG. 1;

FIG. 3 is an exploded view of the connector assembly shown in FIG. 2;

FIG. 4 is another exploded view of the connector assembly shown in FIG. 2; and

FIG. 5 is a cross section review of the electrical adapter along line 5-5 shown in FIG. 1.

### DETAILED DESCRIPTION OF THE INVENTION

Reference will now be made to the drawing figures to describe the present invention in detail.

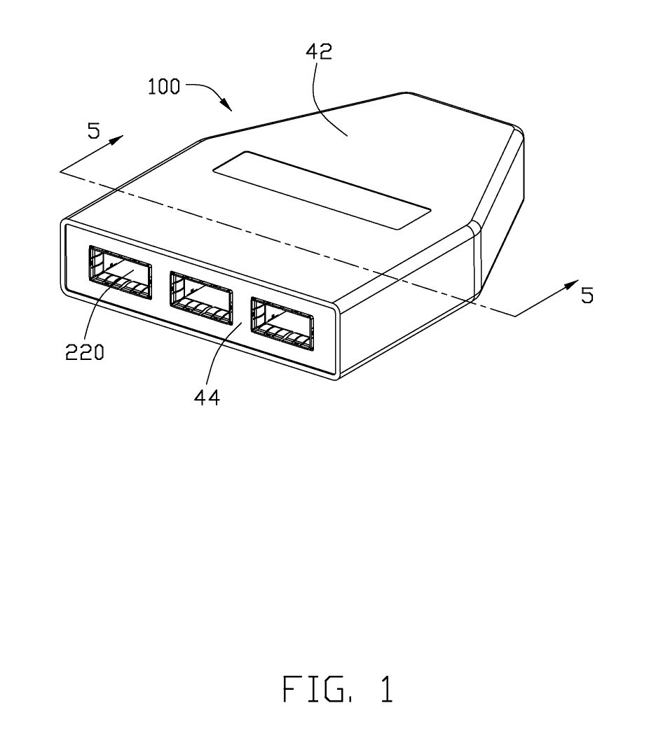

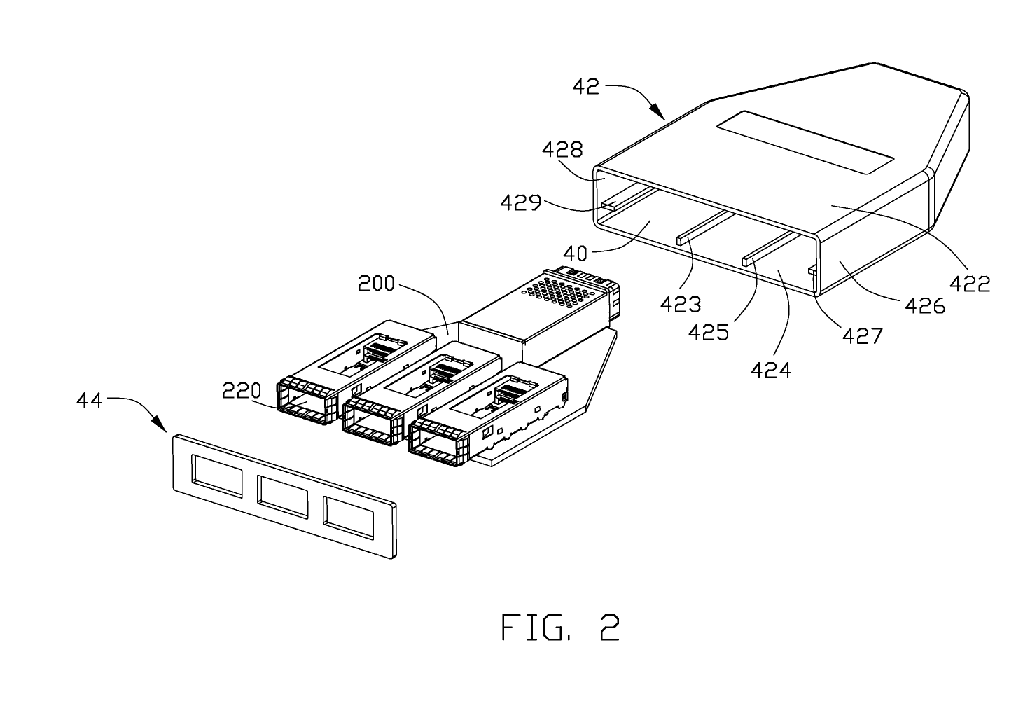

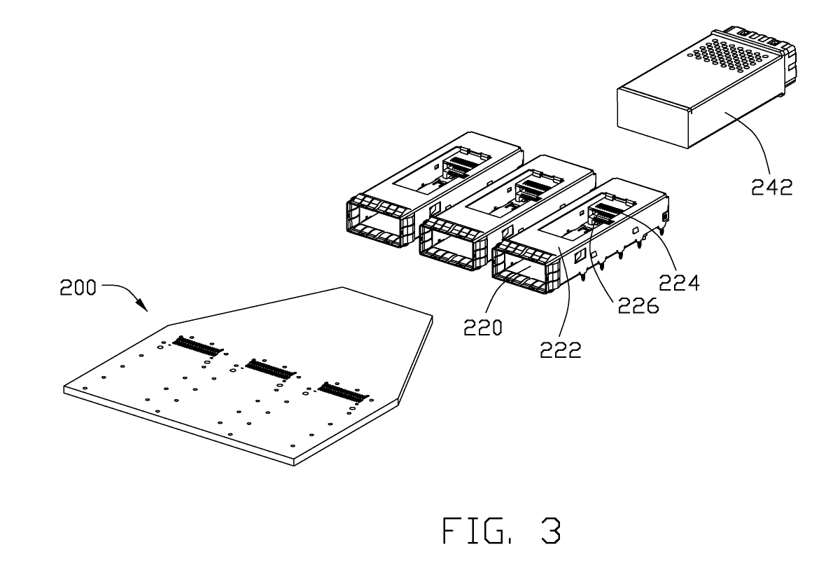

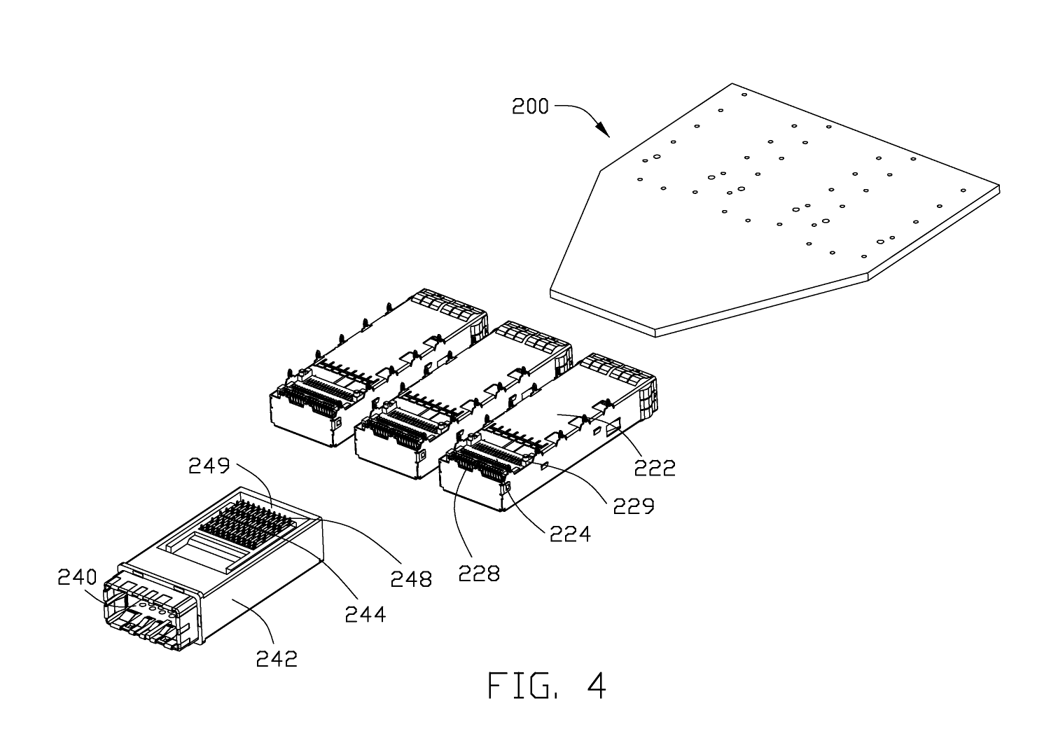

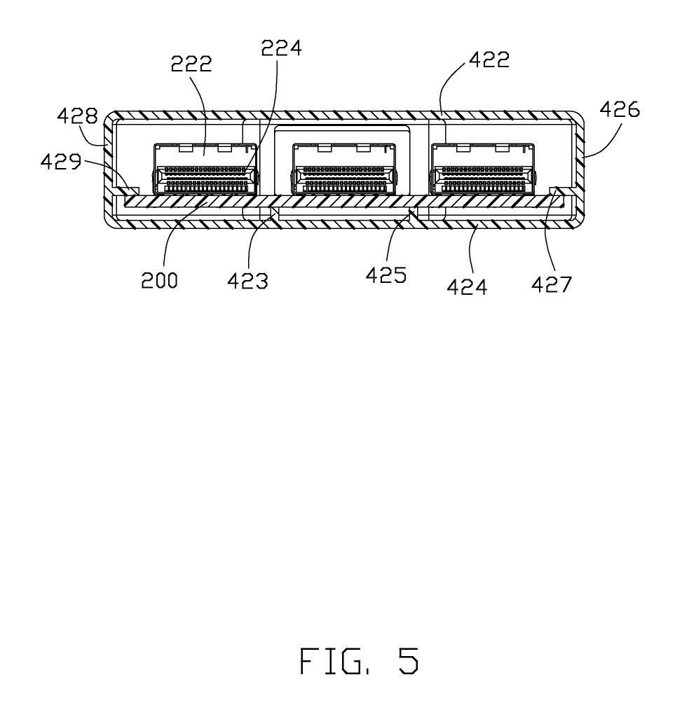

Referring to FIGS. 1-5, an electrical adapter 100, to connect a CXP connector to three QSFP (Quad Small Form Factor Pluggable) connectors is disclosed here. The electrical adapter 100 comprises a connector assembly and a case 42, 44 enclosing the connector assembly. The connector assembly comprises a printed circuit board 200, three QSFP connectors 224 mounted on the printed circuit board 200, three first cages 222 mounted on the printed circuit board 200 side by side along the front edge, a CXP connector 244 mounted on the printed circuit board 200, and a second cage 242 mounted on the printed circuit board 200 along the rear edge. The printed circuit board 200 electrically connects the three QSFP connectors 224 to the CXP connector 244.

Each of the QSFP connectors 224 has four signal channels each supporting transmission rates up to 10.3 Gbit/s. The QSFP connector 224 defines a slot 226 for receiving a card edge of a QSFP plug (not shown). Each of the first cages 222 has a front opening 220 facing forwardly and a rear opening 229 facing to the printed circuit board 200. The QSFP plug could backwardly inserted into the first cage 222 through the front opening 220. The QSFP connector 224 gets upwardly into the first cage 222 through the rear opening 229 when the first cage 222 is mounted onto the printed circuit board 200. It is noted that the construction of a QSFP connector, an associated cage, and its combination is well known in this art.

The CXP connector 244 has twelve channels each supporting transmission rates up to 10.3 Gbit/s. The CXP connector 244 defines a slot 246 for receiving a card edge of a CXP plug (not shown). The second cage 242 has a front opening 240 through which the CXP plug is backwardly inserted into the second cage 242 and a rear opening 249 facing to the printed circuit board 200 through which the CXP connector 244 gets upwardly into the second cage 242 when the second cage 242 is mounted onto the printed circuit board 200. It is noted that the construction of a CXP connector, an associated cage, and its combination is well known in this art.

The case comprises a bushing 42 having a widened front opening 40 and a narrowed rear opening (not shown). The bushing 42 sheathes the connector assembly forwardly till the front openings 220 of the first cages 222 aligned in the front opening 40 of the bushing 42 and the front opening 240 of the second cage 242 aligned in the rear opening of the bushing 42. The bushing 42 has a top wall 422, a bottom wall 424 and two opposite side walls 426, 428 connecting opposite sides of the top wall 422 and the bottom wall 424. The bottom wall 424 upwardly protrudes two ribs 423, 425 supporting a bottom surface of the printed circuit board 200. The two side walls 426, 428 respectively protrude two tabs 427, 729 abutting a top surface of the printed circuit board 200. The case further comprises a board 44 defining three openings (not labeled). The board 44 is mounted in the front opening 40 of the bushing 42 with the three first cages 222 respectively received in the openings of the board 44.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical adapter comprising a connector assembly and a case enclosing the connector assembly, the connector assembly comprising:
a printed circuit board having a front edge and a rear edge;
a first connector mounted on the printed circuit board, the first connector defining a slot for receiving a card edge of a first plug;
a first cage mounted on the printed circuit board near the front edge, the first cage having a front opening through which the first plug is backwardly inserted into the first cage and a rear opening facing to the printed circuit board for receiving the first connector;
a second connector mounted on the printed circuit board, the second connector defining a slot for receiving a card edge of a second plug; and
a second cage mounted on the printed circuit board near the rear edge, the first cage having a front opening through which the second plug is backwardly inserted into the second cage and a rear opening facing to the printed circuit board for receiving the second connector; wherein
the printed circuit board electrically connects the first connector to the second connector.

2. An electrical adapter as claimed in claim 1, wherein the connector assembly further comprises another two first connectors side by side the first connector and another two first cages corresponding receiving said another two first connectors, said another two first connectors being electrically connected to the second electrical connector through the printed circuit board.

3. An electrical adapter as claimed in claim 2, wherein the case comprises a unitarily formed bushing having a widened front opening and a narrowed rear opening, the bushing sheathing the connector assembly forwardly till the front openings of the first cages aligned in the front opening of the bushing and the front opening of the second cage aligned in the rear opening of the bushing

4. An electrical adapter as claimed in claim 3, wherein the bushing has a top wall, a bottom wall, and two opposite side walls connecting the top and the bottom walls.

5. An electrical adapter as claimed in claim 4, wherein the bottom wall upwardly protrudes a rib supporting a bottom surface of the printed circuit board, one of the two sidewall protrudes a tab, and the other sidewall protrudes another tab, said tabs abutting a top surface of the printed circuit board.

6. An electrical adapter as claimed in claim 3, wherein the case further comprises a board defining three openings, the board being mounted in the front opening of the bushing with the three first cages respectively received in the openings of the board.

7. An electrical adapter comprising:
a connector assembly having a first mating port facing forwardly to receive a first plug and a rear mating port facing backwardly for receiving a second plug; and
a case having a unitarily formed bushing sheathing the connector assembly, the bushing having a top wall, a bottom wall, two side walls connecting opposite sides of the top and the bottom walls, and a plurality of protrusions extending from the walls and positioning the connector assembly in the bushing

8. An electrical adapter as claimed in claim 7, wherein the connector assembly comprises a printed circuit board and a first electrical connector corresponding to the first mating port and a second electrical connector corresponding to the second mating port, and the protrusions comprise at least one rib extending from the bottom wall and supporting a bottom surface of the printed circuit board, a tab extending from one of the two side walls and another tab extending from the other side wall, said tabs butting a top surface of the printed circuit board.

9. An electrical adapter as claimed in claim 8, wherein the case further comprises a board mounted in the bushing, the board defining an opening receiving the first mating port through which the first electrical connector is accessable.

10. An electrical adaptor comprising:
a printed circuit board defining opposite first and second halves along a front-to-back direction;
a first connector mounted upon the first half;
a first cage enclosing said first connector and mounted upon the first half, and defining a first horizontal opening for receiving a first plug;
a second connector mounted upon the second half;
a second cage enclosing said second connector, mounted upon the second half, and defining a second horizontal opening for receiving a second plug;
a case enclosing the printed circuit board and the first connector, the first cage, the second connector and the second cage while exposing the first horizontal opening and the second horizontal opening

11. The electrical connector as claimed in claim 10, wherein the first connector is dimensionally and configurationally different from the second connector.

12. The electrical connector as claimed in claim 11, wherein there are at least two first connectors mounted upon the first half and respectively enclosed by the corresponding two first cages while there is only one second connector mounted upon the second half and enclosed by the corresponding second cage.

13. The electrical connector as claimed in claim 12, wherein said first half is wider than the second half

14. The electrical connector as claimed in claim 12, wherein the case defines protrusions to support the printed circuit board.

15. The electrical connector as claimed in claim 10, wherein the first cage defines mounting pins extending through the first half
